(19) United States
(12) Patent Application Publication
(10) Pub. No.: US 2009/0050636 A1
(43) Pub. Date: Feb. 26, 2009

(54) Insulation system

(76) Inventor: Israel Sanchez, Tampa, FL (US)

Correspondence Address: LOUIS J. BRUNOFORTE, 10506 SPRING HILL DRIVE, SPRING HILL, FL, 34608, US

(21) Appl. No.: 11/895,332

(22) Filed: Aug. 24, 2007

(51) Int. Cl. A47J 41/00

(52) U.S. Cl. 220/592.24

(57) ABSTRACT

A cover assembly has a lower section. The lower section is in a cylindrical configuration. The cover assembly has an upper section. The upper section is in a conical configuration. The cover assembly has an intermediate section. The lower section has an open lower end. The upper section has an open upper end. A base is in a flat circular configuration. The base is movable between a closed orientation in contact with the lower end of the lower section and an open orientation spaced from the lower end of the lower section. A strap assembly couples the cover assembly and the base. In this manner the base is secured in the closed orientation. Further in this manner the base is released from the closed orientation.

### BACKGROUND OF THE INVENTION

1. Field of the Invention

The present invention relates to an insulation system and more particularly pertains to maintaining a cold beer bottle at a reduced temperature in an efficient, convenient and economical manner.

2. Description of the Prior Art

The use of beverage holders of known designs and configurations is known in the prior art. More specifically, beverage holders of known designs and configurations previously devised and utilized for the purpose of insulating a beverage through known methods and apparatuses are known to consist basically of familiar, expected, and obvious structural configurations, notwithstanding the myriad of designs encompassed by the crowded prior art which has been developed for the fulfillment of countless objectives and requirements.

By way of example, U.S. Pat. No. 4,802,602 issued Feb. 7, 1989 to Evans relates to an Insulating Device for a Beverage Container. U.S. Pat. No. 5,325,991 issued Jul. 5, 1994 to Williams relates to an Adjustable Multi-Purpose Drink Holder with Detachable insulator Blanket. U.S. Pat. No. 6,145,715 issued Nov. 14, 2000 to Slonim relates to a Belt and Bicycle Mountable Beverage Holder. Lastly, U.S. Pat. No. 6,286,798 issued Sep. 11, 2001 to Chum relates to a Versatile Beverage Container Holder.

While these devices fulfill their respective, particular objectives and requirements, the aforementioned patents do not describe an insulation system that allows for maintaining a cold beer bottle at a reduced temperature in an efficient, convenient and economical manner.

In this respect, the insulation system according to the present invention substantially departs from the conventional concepts and designs of the prior art, and in doing so provides an apparatus primarily developed for the purpose of maintaining a cold beer bottle at a reduced temperature in an efficient, convenient and economical manner.

Therefore, it can be appreciated that there exists a continuing need for a new and improved insulation system which can be used for maintaining a cold beer bottle at a reduced temperature in an efficient, convenient and economical manner. In this regard, the present invention substantially fulfills this need.

### SUMMARY OF THE INVENTION

In view of the foregoing disadvantages inherent in the known types of beverage holders of known designs and configurations now present in the prior art, the present invention provides an improved insulation system. As such, the general purpose of the present invention, which will be described subsequently in greater detail, is to provide a new and improved insulation system and method which has all the advantages of the prior art and none of the disadvantages.

To attain this, the present invention essentially comprises an insulation system. First provided is a cover assembly. The cover assembly is symmetrically formed about a major axis. The cover assembly has an axial length. The cover assembly has a lower section. The lower section is in a cylindrical configuration. The axis of the lower section is coincident with the major axis. The lower section has an axial length. The axial length of the lower section is greater than 50 percent of the length of the cover assembly. The cover assembly also has an upper section. The upper section is in a conical configuration. The axis of the upper section is coincident with the major axis. The cover assembly also has an intermediate section. The intermediate section is in an axially symmetric configuration. The intermediate section couples the upper and lower sections. The axis of the intermediate section is coincident with the major axis. The axial length of the upper section is greater than the axial length of the intermediate section. The lower section has an open lower end. A cold beer bottle is provided. The open lower end receives the cold beer bottle. The lower section has a bottom end. The bottom end is positionable adjacent to the open lower end of the lower section. The upper section has an open upper end. The open upper send receives the cold beer bottle. The lower section has a top end. The top end is positionable in proximity to the open upper end of the upper section. The cover assembly has an interior surface. The interior surface is adapted to contact a cold beer bottle about its external periphery. The cover assembly further has an exterior surface. The exterior surface is adapted to be contacted by a user drinking from the cold beer bottle.

A base is provided. The base is in a flat circular configuration. The base has an interior surface. The base has an exterior surface. The base is movable between an open orientation and a closed orientation. The interior surface of the base when in the closed orientation is in contact with the lower end of the lower section. The interior surface of the base is adapted to contact a cold beer bottle at its bottom. The interior surface of the base when in the open orientation is spaced from the lower end of the lower section. The interior surface is adapted to allow passage of a cold beer bottle into and out of the cover assembly.

Further provided is a strap assembly. The strap assembly has a pivot strap. The pivot strap is formed as an integral extension of the base. The pivot strap is fixedly secured to the exterior surface of the lower section at a location adjacent to the lower end. The strap assembly also has a locking strap. The locking strap is formed as an integral extension of the base diametrically opposed from the pivot strap. The locking strap has a free end. The strap assembly also has a first Velcro member. The first Velcro member is fixedly secured to the exterior surface of the lower section at a location diametrically opposed from the pivot strap. The strap assembly has a second Velcro member. The second Velcro member is secured to the free end of the locking strap. In this manner the Velcro members are adapted to be releasably coupled. Also in this manner the base is secured in the closed orientation. Further in this manner the Velcro members are adapted to be separated to release the base from the closed orientation to the open orientation. The cover assembly and base and straps are fabricated of a gel pack material. Typical materials for the fabrication of the gel pack material are described in U.S. Pat. Nos. 4,783,866 and 4,953,550, the subject matter of such patents is incorporated herein by reference.

Provided last is an exterior covering. The exterior covering has lower and upper and intermediate sections. The sections are of a size and shape corresponding to the size and shape of the cover assembly. The sections are removably secured over the entire exterior surface of the cover assembly. The exterior covering is fabricated of a neoprene sponge wet suit material. Typical materials for the fabrication of the neoprene sponge wet suit material are described in U.S. Pat. Nos. 4,276,341 and 6,698,510, the subject matter of such patents is incorporated herein by reference.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims attached.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved insulation system which has all of the advantages of the prior art beverage holders of known designs and configurations and none of the disadvantages.

It is another object of the present invention to provide a new and improved insulation system which may be easily and efficiently manufactured and marketed.

It is further object of the present invention to provide a new and improved insulation system which is of durable and reliable constructions.

An even further object of the present invention is to provide a new and improved insulation system which is susceptible of a low cost of manufacture with regard to both materials and labor, and which accordingly is then susceptible of low prices of sale to the consuming public, thereby making such insulation system economically available to the buying public.

Even still another object of the present invention is to provide an insulation system for maintaining a cold beer bottle at a reduced temperature in an efficient, convenient and economical manner.

Lastly, it is an object of the present invention to provide a new and improved insulation system. A cover assembly has a lower section. The lower section is in a cylindrical configuration. The cover assembly has an upper section. The upper section is in a conical configuration. The cover assembly has an intermediate section. The lower section has an open lower end. The upper section has an open upper end. A base is in a flat circular configuration. The base is movable between a closed orientation in contact with the lower end of the lower section and an open orientation spaced from the lower end of the lower section. A strap assembly couples the cover assembly and the base. In this manner the base is secured in the closed orientation. Further in this manner the base is released from the closed orientation.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a front elevational view of an insulation system constructed in accordance with the principles of the present invention.

FIG. 2 is a bottom view of the system taken along line 2-2 of FIG. 1.

FIG. 3 is a side elevational view of the system taken along line 3-3 of FIG. 1.

FIG. 4 is a cross sectional view of the system taken along line 4-4 of FIG. 2.

FIG. 5 is a cross sectional view similar to FIG. 4 but illustrating an alternate embodiment of the invention.

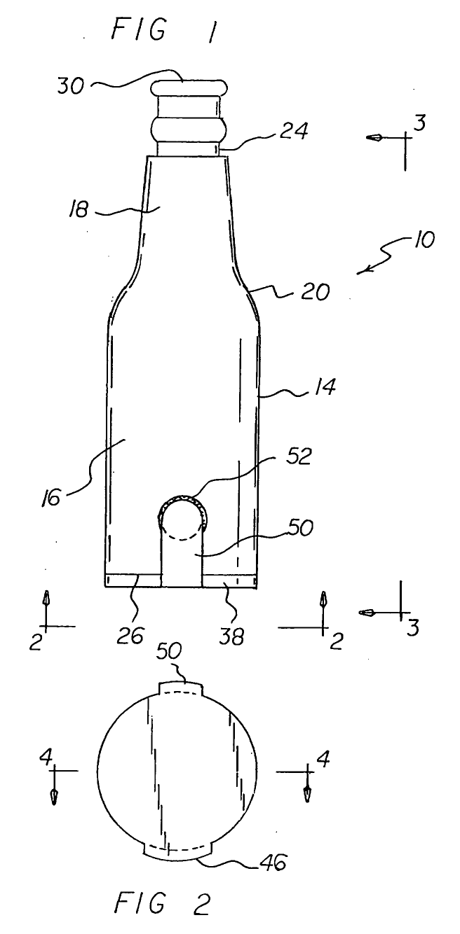

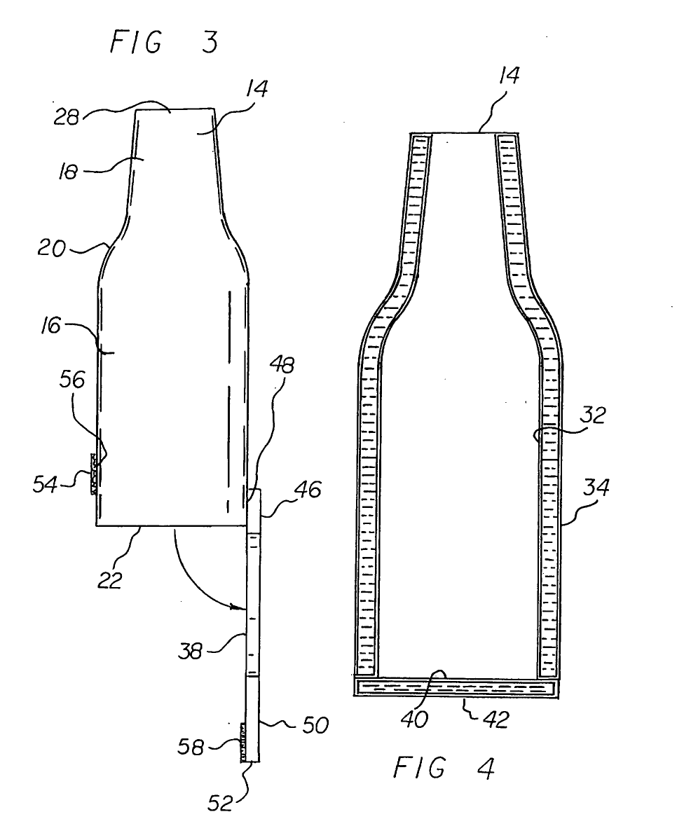

The same reference numerals refer to the same parts throughout the various Figures.

### DESCRIPTION OF THE PREFERRED EMBODIMENT

With reference now to the drawings, and in particular to FIG. 1 thereof, the preferred embodiment of the new and improved insulation system embodying the principles and concepts of the present invention and generally designated by the reference numeral 10 will be described.

The present invention, the insulation system 10 is comprised of a plurality of components. Such components in their broadest context include a cover assembly, a base and a strap. Such components are individually configured and correlated with respect to each other so as to attain the desired objective.

First provided is a cover assembly 14. The cover assembly is symmetrically formed about a major axis. The cover assembly has an axial length. The cover assembly has a lower section 16. The lower section is in a cylindrical configuration. The axis of the lower section is coincident with the major axis. The lower section has an axial length. The axial length of the lower section is greater than 50 percent of the length of the cover assembly. The cover assembly also has an upper section 18. The upper section is in a conical configuration. The axis of the upper section is coincident with the major axis. The cover assembly also has an intermediate section 20. The intermediate section is in an axially symmetric configuration. The intermediate section couples the upper and lower sections. The axis of the intermediate section is coincident with the major axis. The axial length of the upper section is greater than the axial length of the intermediate section. The lower section has an open lower end 22. A cold beer bottle 24 is provided. The open lower end receives the cold beer bottle. The lower section has a bottom end 26. The bottom end is positionable adjacent to the open lower end of the lower section. The upper section has an open upper end 28. The open upper send receives the cold beer bottle. The lower section has a top end 30. The top end is positionable in proximity to the open upper end of the upper section. The cover assembly has an interior surface 32. The interior surface is adapted to contact a cold beer bottle about its external periphery. The cover assembly further has an exterior surface 34. The exterior surface is adapted to be contacted by a user drinking from the cold beer bottle. Bottles with other beverages, beverages other than beer, are readily adapted to be utilized and maintained cold by the cover assembly of the present invention.

A base 38 is provided. The base is in a flat circular configuration. The base has an interior surface 40. The base has an exterior surface 42. The base is movable between an open orientation and a closed orientation. The interior surface of the base when in the closed orientation is in contact with the lower end of the lower section. The interior surface of the base is adapted to contact a cold beer bottle at its bottom. The interior surface of the base when in the open orientation is spaced from the lower end of the lower section. The interior surface is adapted to allow passage of a cold beer bottle into and out of the cover assembly.

Further provided is a strap assembly. The strap assembly has a pivot strap 46. The pivot strap is formed as an integral extension of the base. The pivot strap is fixedly secured to the exterior surface of the lower section at a location 48 adjacent to the lower end. The strap assembly also has a locking strap 50. The locking strap is formed as an integral extension of the base diametrically opposed from the pivot strap. The locking strap has a free end 52. The strap assembly also has a first Velcro member 54. The first Velcro member is fixedly secured to the exterior surface of the lower section at a location 56 diametrically opposed from the pivot strap. The strap assembly has a second Velcro member 58. The second Velcro member is secured to the free end of the locking strap. In this manner the Velcro members are adapted to be releasably coupled. Also in this manner the base is secured in the closed orientation for retaining a beer bottle within the cover assembly. Further in this manner the Velcro members are adapted to be separated to release the base from the closed orientation to the open orientation so as to allow a beer bottle to be introduced into or removed from the cover assembly. The cover assembly and base and straps are fabricated of a gel pack material. The gel pack is adapted to be frozen prior to receiving a cold beer bottle for maintaining the beer bottle colder for a longer period of time. Typical materials for the fabrication of the gel pack material are described in U.S. Pat. Nos. 4,783,866 and 4,953,550, the subject matter of such patents is incorporated herein by reference.

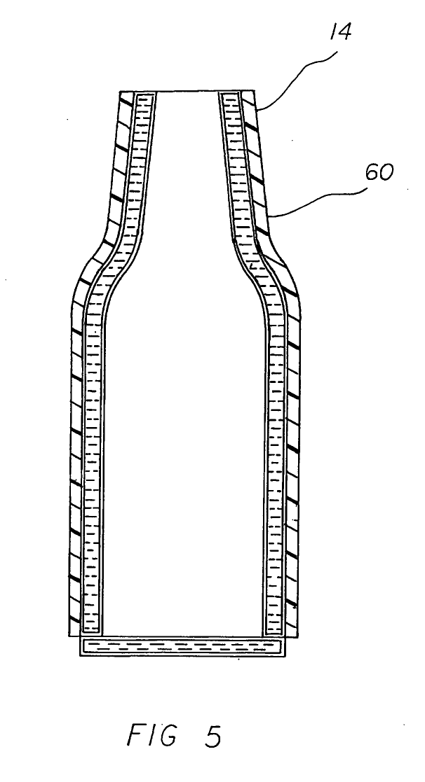

FIG. 5 is a cross sectional view similar to FIG. 4 but illustrating an alternate embodiment of the invention. Such embodiment includes all of the components of the primary embodiment described above including the cover assembly. There is, however, an additional component, an exterior covering 60. The exterior covering has lower and upper and intermediate sections. The sections are of a size and shape corresponding to the size and shape of the cover assembly. The sections are removably secured over the entire exterior surface of the cover assembly. The exterior covering is fabricated of a neoprene sponge wet suit material to facilitate handling of the system. Typical materials for the fabrication of the neoprene sponge wet suit material are described in U.S. Pat. Nos. 4,276,341 and 6,698,510, the subject matter of such patents is incorporated herein by reference.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is as follows:

1. An insulation system comprising:
a cover assembly including a lower section in a cylindrical configuration and an upper section in a conical configuration and an intermediate section, the lower section having an open lower end, the upper section having an open upper end;
a base in a flat circular configuration movable between a closed orientation in contact with the lower end of the lower section and an open orientation spaced from the lower end of the lower section; and
a strap assembly coupling the cover assembly and the base to secure the base in the closed orientation and to release the base from the closed orientation.

2. The system as set forth in claim 1 wherein the strap assembly includes a pivot strap formed as an integral extension of the base and fixedly secured to the exterior surface of the lower section at a location adjacent to the lower end, the strap assembly also including a locking strap formed as an integral extension of the base diametrically opposed from the pivot strap with a free end, the strap assembly also including a first Velcro member fixedly secured to the exterior surface of the lower section at a location diametrically opposed from the pivot strap and a second Velcro member secured to the free end of the locking strap whereby the Velcro members are adapted to be releasably coupled to secure the base in the closed orientation and whereby the Velcro members are adapted to be separated to release the base from the closed orientation to the open orientation.

3. The system as set forth in claim 1 wherein the cover assembly and base are fabricated of a gel pack material.

4. The system as set forth in claim 1 and further including an exterior covering having lower and upper and intermediate sections of a size and shape corresponding to the size and shape of the cover assembly secured over the entire exterior surface of the cover assembly.

5. The system as set forth in claim 4 wherein the exterior covering is fabricated of a wet suit material.

6. An insulation system for maintaining a cold beer bottle at a reduced temperature in an efficient, convenient and economical manner comprising, in combination:
a cover assembly symmetrically formed about a major axis with an axial length, the cover assembly including a lower section in a cylindrical configuration with an axis coincident with the major axis and with an axial length greater than 50 percent of the length of the cover assembly, the cover assembly also including an upper section in a conical configuration with an axis coincident with the major axis, the cover assembly also including an intermediate section in an axially symmetric configuration coupling the upper and lower sections and with an axis coincident with the major axis, the axial length of the upper section being greater than the axial length of the intermediate section, the lower section having an open lower end for the receipt of a cold beer bottle with a bottom end positionable adjacent to the open lower end of the lower section, the upper section having an open upper end for the receipt of a cold beer bottle with a top end positionable in proximity to the open upper end of the upper section, the cover assembly having an interior surface adapted to contact a cold beer bottle about its external periphery and an exterior surface adapted to be contacted by a user drinking from the cold beer bottle;
a base in a flat circular configuration with an interior surface and an exterior surface, the base being movable between an open orientation and a closed orientation, the interior surface of the base when in the closed orientation being in contact with the lower end of the lower section and adapted to contact a cold beer bottle at its bottom, the interior surface of the base when in the open orientation being spaced from the lower end of the lower section and adapted to allow passage of a cold beer bottle into and out of the cover assembly;
a strap assembly including a pivot strap formed as an integral extension of the base and fixedly secured to the exterior surface of the lower section at a location adjacent to the lower end, the strap assembly also including a locking strap formed as an integral extension of the base diametrically opposed from the pivot strap with a free end, the strap assembly also including a first Velcro member fixedly secured to the exterior surface of the lower section at a location diametrically opposed from the pivot strap and a second Velcro member secured to the free end of the locking strap whereby the Velcro members are adapted to be releasably coupled to secure the base in the closed orientation and whereby the Velcro members are adapted to be separated to release the base from the closed orientation to the open orientation, the cover assembly and base and straps being fabricated of a gel pack material; and
an exterior covering having lower and upper and intermediate sections of a size and shape corresponding to the size and shape of the cover assembly removably secured over the entire exterior surface of the cover assembly, the exterior covering being fabricated of a neoprene sponge wet suit material.
